(19) United States
(12) Patent Application Publication
(10) Pub. No.: US 2014/0271290 A1
(43) Pub. Date: Sep. 18, 2014

(54) QUICK LOCK AND RELEASE DEVICE PREVENTING UNWANTED LOOSENING OF A PACKING NUT OF A PLUNGER PUMP DURING OPERATION OF THE PUMP

(71) Applicant: TCM INVESTMENTS, INC., Tulsa, OK (US)

(72) Inventors: Nikolas Ryan DAVIS, Catoosa, OK (US); Jacob Daniel RUPP, Broken Arrow, OK (US)

(73) Assignee: TCM INVESTMENTS, INC., Tulsa, OK (US)

(21) Appl. No.: 13/799,090

(22) Filed: Mar. 13, 2013

(51) Int. Cl. F04B 53/02; F16B 39/02

(52) U.S. Cl. CPC F04B 53/02; F16B 39/02
USPC 417/437; 29/428; 411/191

(57) ABSTRACT

A pump has a packing nut extending into an open end of the plunger bore and a device coupled to the packing nut. The device includes first body coupled to a second body to form a body of the device. A first post connected to the body and a second post connected to the body. The first post extending into a first opening of the packing nut and the second post extends into a second opening of the packing nut to couple said device to said packing nut. A stop forms a portion of the device. When the body is in a locked orientation, the stop of the device abuts or will abut, when the nut is rotated in a loosening direction, a connecting assembly of the pump. When the body is in the unlocked orientation, the second post is moveable, relative to the first body and the first post, in a direction out of the second opening, and a first portion of said second body, exclusive of said second post, is moveable in a direction relative to said first body and first post.

### FIELD

The present disclosure concerns a device which quickly couples and locks to a packing nut. When the device is locked in place on the nut, the device prevents an unwanted loosening of the nut from an open end of a plunger bore into which the nut extends.

### BACKGROUND

The construction of high pressure plunger pumps is well known. The pumps are used in a variety of applications including well servicing. FIGS. 1, 2 and 3 show a prior art example of a high pressure plunger pump 30. FIG. 3 shows the pump 30 coupled to a prior art device 32. The device 32 is coupled to a packing nut 555 of the prior art pump to prevent an unwanted loosening of the packing nut 555.

The plunger pump 30 has a power end 36 connected to a fluid end 38. A plurality of connecting assemblies 40 fixedly connects the fluid end 38 to the power end 36. Each connecting assembly 40 has a threaded stud 42 which serves to make the fixed connection. Each connecting assembly includes a spacer 44 which is a hollow tube. The stud 42 extends into the tube 44. Each assembly 40, and its corresponding stud 42 and tube 44 has a long axis 45. Each assembly 40 and its corresponding tube 44 and stud 42 has portions between the fluid end 38 and power end 36. The tube 44 of each assembly serves to space the fluid end 38 from the power end 36. The spacing extends in the direction along the long axis 45 of the tube and stud. The power end 36 reciprocates a plurality of plungers 47 in a plurality of plunger bores 49. Each plunger bore 49 is formed in a different portion of the fluid end 38. Each bore 49 of the plurality of bores corresponds to a different one of the plurality of plungers 47. Each plunger 47 has a long axis 51 along which it reciprocates. The reciprocation draws fluid, in this case liquid, in and out of the fluid end 38 of the pump 30. The liquid discharged from the fluid end 38 has a use depending on the application of the pump 30.

Each of the plunger bores 49 has an open end 49′ from which its corresponding plunger 47 extends. A portion of each plunger 47 which extends through an open end 49′ of its corresponding plunger bore 49 is coupled to the power end by a pony rod. To ensure that liquid being pumped does not leek from the open end 49′ of each plunger bore 49 during reciprocation of its corresponding plunger 47 in the open end 49′, a packing 53 is disposed in each bore 49 between a plunger outer surface 47′ and a surface of the fluid end delimiting a boundary of the corresponding plunger bore 49. There is a plurality of packing nuts 55 disposed in the fluid end 38. A different one of the pluralities of nuts 55 extends into each open end 49′ of each plunger bore 49. Each nut 55 is threadably coupled to the fluid end 38 at the bore open end 49′ into which it extends. Each nut is thus rotatably coupled to the fluid end 38. Each packing nut 55 helps to hold the packing 53 disposed in its corresponding bore 49 in place. The packing nut has a hole through which its corresponding plunger reciprocates. During operation of the pump, over a period of time, unless restrained, the packing nuts 55 tend to loosen. A loosened packing nut 55 can allow for the liquid being pumped to leak out of the open end 49′ into which the loosened packing nut 55 extends.

To inhibit loosening of a packing nut 55, device 32, which can be called a tool or stop or retainer, is coupled to the packing nut 55. FIG. 3 shows the device 32 coupled to one of packing nut's 55. For clarity the nut 55 to which the device is coupled is also designated as 555. The device, also shown in FIG. 4, has a body 57 which couples to the nut 555 at the first surface 55′ of the nut. The first surface 55′ can also be called an outer surface 55′. The device 32 also has a stop portion 59 which is spaced away from an outer surface 57′ of the body at least a distance to ensure that when the tool 32 is installed, the stop 59 will abut a connecting assembly 40 at the time of installation or when the nut rotates a bit in the loosening direction 61. For clarity of discussion, the assembly 40 to which the stop abuts or will abut, is also designated 400. The abutment prevents the nut 555 from loosening to a degree that liquid will leak out of the bore open end 49′ into which the nut 555 extends during operation of the pump. The stop 59 is at an end portion of a handle 63 which extends from the body 57. As shown in FIG. 4 the body has two posts 65, 67 which extend from an inner circumferential surface 57″ of the body 57. When the body 57 is coupled to the nut 555, the posts 65, 67 are disposed in corresponding holes of the nut. The corresponding holes extend through first surface 55′ of the nut. A long axis of the handle intersects one of the posts 67. The post 67 is retractable by movement of a lever 69 carried by the handle 63. Movement of the lever 69 in a first direction 71 retracts the post 67 to a first position so that the post free end 67′ does not extend out from the inner surface 57″. The post 67 is in the retracted position when the device 32 is being installed by an operator on the nut 555. To complete installation the post is moved, by moving the lever in a second direction 72 which moves the post 67 into an extended position to extend into a corresponding hole in the nut 555. When the device is in the installed position it will not come off the nut 555 during normal operation of the pump. Further an operator cannot remove the device from the nut 555 by hand. To remove the device from the nut 555, the post 67 is moved by moving the lever 69 in the first direction 71 to move the post to the retracted position.

FIG. 5 discloses an alternative device 33 for retaining packing nut 555. The device has a construction different than device 32. The device has a body 74. The body 74 includes one post 76 which extends from the inner surface of the body 74. The device 33 is coupled to the nut 555 and oriented into an installed position by inserting the post 76 in a corresponding hole in nut surface 55′ of the nut 555. The body 74 is than secured to a portion of the fluid end 38 by fasteners 80. Fixedly mounting the body to the fluid end 38 prevents the nut 555 from rotating.

### SUMMARY

In one example of the invention a plunger pump has a plunger bore; a packing nut extends into an open end of the plunger bore. A plurality of connecting assemblies of the pump couple a power end of the pump to a fluid end of the pump. A device is coupled to the packing nut to prevent an unwanted loosening of the packing nut.

The device has a first body coupled to a second body. The first and second bodies form a body of the device. The device has a first post and a second post. The first post extends into a first opening and the second post extends into a second opening to couple the device to the packing nut. The device has a stop wherein when the body is in a locked orientation, the stop abuts or will abut, when the nut is rotated in a loosening direction, one of the connection assemblies.

The body of the device is adjustable between an unlocked orientation and the locked orientation. In the unlocked orientation, the second post is moveable, relative to the first body and said first post, in a direction out the second opening, and a first portion of the second body, exclusive of said second post, is moveable in a direction relative to said first body and first post. Preferably the first body is pivotally coupled to the second body.

In another example of the invention a device adapted to retain a packing nut of a plunger pump from an unwanted loosening during operation of the plunger pump is provided. The device has a first body pivotally coupled to a second body. The first and second bodies form a body. The first body has a first section and a second section. The second section has a curved surface. The second body has a first section and a second section. The second section has a curved surface. A first post is coupled to the second section of the first body. A second post is coupled to the second section of the second body. A stop is connected to the first section of the second body. The body is adjustable between an unlocked orientation and a locked orientation. In the unlocked orientation, the second post is pivotal, relative to said first body and said first post. Also in the unlocked position the first post is pivotal, relative to said second body and the second post. Preferably the second post extends away from the second section of the second body in a direction which points from the first section to the second section of the second body and away from the curved surface of the second body. Also the first post extends away from the second section of the first body in a direction which points from the first section to the second section of the first body and away from the curved surface of the first body.

The device in one embodiment includes a hinge coupling a portion of the first body to a portion of the second body, and the hinge allows for movement, when the body is in the unlocked position, of the second post relative to the first body and the first post; and for movement, when the body is in the unlocked position, of the first post relative to the second body and second post.

In yet a further example of the invention a method of coupling a device to a packing nut extending into an open end of a plunger bore of a plunger pump prevent an unwanted loosening of the nut from the open end during operation of the pump is provided. The method includes slidably inserting a first post connected to a body of the device into a first hole to couple of the body to the nut. The body has a first body pivotally connected to a second body. The method further includes moving and pivoting a second post connected to the body, relative to the first body and first post, in a second curved direction and along a second curved path and while moving and pivoting the second post in the second curved direction and along the second curved path, slidably inserting the second post into a second hole to couple the body to the nut. The second post's ability to move and pivot, relative to the first body and first post, in a first curved direction and along a first curved path, opposite the second curved direction and path is restrained.

### BRIEF DESCRIPTION OF THE DRAWINGS

FIG. 1 is a top and side isometric view of a prior art plunger pump.

FIG. 2 is a close up side view of detail A of the pump shown in FIG. 1.

FIG. 3a is a cross-sectional view of the portion of the pump of FIG. 1 shown in FIG. 2 taken along view line 3a-3a which is taken and along a plane parallel to and through the plungers and plunger bores.

FIG. 3b is a stripped down view of a portion of the pump portion shown in FIG. 2; the view is taken along view line 3b-3b which is taken and along a plane perpendicular to and extending through some of the connecting assemblies coupling the pump's fluid end to the pump's power end; the view looks into a side of the fluid end into which retaining nuts of the pump extend; a prior art retaining device is coupled to one of the shown retaining nut and serves to prevent an unwanted loosening of the retaining nut; the plunger has been intentionally omitted from the view.

FIG. 4 is a side view of the prior art retaining device shown in FIG. 3b.

FIG. 5 is a side view of an alternative prior art retaining device.

FIG. 6a is the cross-sectional view of the portion of the pump shown in FIG. 3b; the view is taken and along a plane perpendicular to and extending through some of the connecting assemblies coupling the pump's fluid end to the pump's power end; the view looks into a side of the fluid end into which retaining nuts of the pump extend; a retaining device embodying the features of the present invention is coupled, in a locked orientation, to one of the retaining nuts and serves to prevent an unwanted loosening of the retaining nut; the plunger has been intentionally omitted.

FIG. 6b is the cross-sectional view of the pump of FIG. 6a; the retaining device of FIG. 6a is being removed from the retaining nut of FIG. 6a; the device is in the unlocked orientation.

FIG. 7 is a close-up sectional view of the retaining nut and device shown in FIG. 6b; the section is perpendicular to and passes through an axis of the nut; the section also passes through the device and outer surface of the nut; the view is from the reverse side of the nut shown in FIG. 6b; the nut and device are floating in space.

FIG. 8a is a first side view of the retaining device shown in FIG. 6a in the locked orientation and in a set orientation, the device is exclusive of the pump.

FIG. 8b is the first side view of the retaining device shown in FIG. 8a, except the device is in the unlocked orientation; the second body first end portion and second post of the device has been pivoted relative to the first body of the device; the device is exclusive of the pump.

FIG. 8c is the first side view of the retaining device shown in FIG. 8a, except the device is unhinged so the first body of the device is uncoupled form the second body of the device.

FIG. 9a is a second side view of the device shown in FIG. 8a; the second side view is opposite the first side view; the orientation of the device is the same as in FIG. 8a.

FIG. 9b is the second side view of the device shown in FIG. 8b; the second side view is opposite the first side view; the orientation of the device is the same as in FIG. 8b.

FIG. 9c is the second side view of the retaining device shown in FIG. 9a, except the device is unhinged so the first body of the device is uncoupled form the second body of the device.

FIG. 10a is a top view of the device shown in FIG. 8a; the orientation of the device is the same as in FIG. 8a.

FIG. 10b is the top view of the device shown in FIG. 8b; the orientation of the device is the same as in FIG. 8b.

FIG. 11a is a bottom view of the device shown in FIG. 10a; the bottom view is opposite the top view; the orientation of the device is the same as in FIG. 10a.

FIG. 11b is the bottom view of the device shown in FIG. 10b; the Bottom view is opposite the top view; the orientation of the device is the same as in FIG. 10b.

FIG. 12a is a first end view of the device shown in FIG. 8a; the orientation of the device is the same as in FIG. 8a.

FIG. 12b is the first end view of the device shown in FIG. 8b; the orientation of the device is the same as in FIG. 8b.

FIG. 13a is a second end view of the device shown in FIG. 12a; the second end view is opposite the first end view; the orientation of the device is the same as in FIG. 12a.

FIG. 13b is the second end view of the device shown in FIG. 12b; the second end view is opposite the first end view; the orientation of the device is the same as in FIG. 12b.

FIG. 14a is an isometric first side view of the device shown in FIG. 8a; the orientation of the device is the same as in FIG. 8a.

FIG. 14b is an isometric first side view of the device shown in FIG. 8b; the orientation of the device is the same as in FIG. 8b.

### DETAILED DESCRIPTION

FIG. 6 shows an example of the present invention which includes a device 100 which couples to one of the packing nuts 55 of pump 30 to inhibit loosening and preferably prevent unwanted loosening of the nut 55. The nut to which device 100 is coupled, for clarity of discussion, is also labeled 555 and is the same nut as nut 555 called out in the background section of the present disclosure. The device 100 can be called a tool or a stop or a retainer. The device 100 has a body 102 which includes a first body portion 104. The first body 104 has and includes a first post 106. The term base can be used in place of body. The body 102 also has a second body portion 108. The second body has and includes as second post 110. The first and second body portions 104, 108 can also be called first body 104 and second body 108. The first body portion 104 is moveably coupled to the second body portion 108. The first body 104 and second body 108 portions are pivotally coupled to the each other and are each pivotally moveable relative to each other. The first 104 and second 108 body portions are coupled to each other by a hinge 112. The first body 104 and second body 108 are each moveable and pivotal relative to each other when the body 102 is in an unlocked orientation. The body 102 also has a locked orientation. In the locked orientation the movement, including the pivotal movement, of the first body 104 and the second body 108 relative to each other is restrained compared to when the body 102 is not in the locked orientation. The movement is restrained enough to prevent unwanted movement. When the body 102 is not in the locked orientation, it can said to be in the unlocked orientation.

To install the device 100 on nut 555, the body 102 is adjusted or placed in the unlocked orientation. Then the second body 108 and post 110 is moved and pivoted relative to the first body portion 104 and post 106. A second body 108 first portion 118 and post 110 is moved and pivoted relative to first body 104 and post 106. The first portion 118 moves and pivots along a first arcuate path in a first arcuate direction. The first arcuate path and first arcuate direction are shown by arrow 122. The second post 110 moves and pivots along another first arcuate path and in an arcuate direction shown by arrow 122′. The paths and directions 122 and 122′ are in the same general arcuate direction. Pivotal movement of the second body first portion 118 in direction and along path 122 pivotally moves the second post 110, relative to the first body 104 and post 106 along path and in direction 122′. The pivotal movement in the arcuate directions and paths 122, 122′ can be from when the body 102 is oriented in a set orientation which can also be called a set position. In the set position, the second body first portion 118 has been pivoted and moved in a second arcuate direction and path as shown by arrow 120, and post 110 has been pivoted and moved in another second arcuate path and direction as shown by arrow 120′; each a maximal amount relative to the first body portion 104 and post 106. The first arcuate paths and directions 122, 122′ are, respectively, opposite the second arcuate paths and directions 120, 120′. Hinge 112 allows the above movements.

Once the post 110 and first portion 118 are moved and pivoted in the first arcuate directions 122, 122′, the post 106 of the first body portion 104 is inserted into a first hole 114 extending through nut first surface 55′. The post 110 of the second body portion 108 is then inserted into a second hole 116 extending through nut first surface 55′. The post 110 of the second body portion 108 is inserted in the second hole 116 by moving and pivoting first portion 118 and post 110 of the second body portion relative to the first body portion 104 and first post 106. The first portion 118 can be an end portion. The portion of the second body forming the first portion 118 does not have to but can include second post 110. The second body 108 first portion 118 is moved and pivoted relative to the first body 104 and post 106 so that second body first portion 118 is moved along second arcuate path in second arcuate direction 120 and post 110 is moved and pivoted along second arcuate path and direction 120′ to insert the second post 110 into the second hole 116. Pivotal movement of the second body first portion 118 in direction 120 moves the second post 110 relative to the first post 106 and body 106 along arcuate path and direction 120′. Hinge 112 allows the above movements.

The holes 114, 116 in which the posts 106, 110 are inserted are selected so that once the posts 106, 110 have been inserted into the holes 114, 116 and the body 102 has been oriented to the locked orientation, a stop 124 of the device 100 abuts or will abut, when the nut 555 is rotated in the loosening direction 61, connecting assembly 400 of assemblies 40. Accordingly, at installation, the stop 124 of the device 100, when the body is in the locked orientation, will abut connecting assembly 400 at the time of installation or when the nut rotates a bit in the loosening direction 61. The connecting assembly to which the stop 124 abuts or will abut, for clarity of discussion, is called out as connecting assembly 400, which is the same assembly 400 referenced in the background section. Once the posts 106, 110 are inserted into the selected holes 114, 116 and the body is still in the unlocked orientation, the device 102 is in the preinstalled position. Once in the preinstalled position, the body 102 is adjusted from the unlocked orientation to the locked orientation. In the locked orientation, regardless of whether device 100 is coupled to nut 555, the movement, including pivotal movement, of each of the first 104 and second 108 body relative to each other, and the portion 118 and post 110 relative to body 104 and post 106, is restrained compared to when the body 102 is in an unlocked orientation. Accordingly, in the locked orientation, the second body 108 first portion 118 and second post's 110 ability to move and pivot relative to the first body 104 and first post 106 in the first arcuate directions and paths 122, 122′, is restrained compared to when the body 102 is in the unlocked position. The restraint is preferably sufficient so that the first body 104 is substantially immoveable relative to second body 108. The restraint of movement means that the device, when coupled to the nut and in the locked orientation, will not come off the nut 555 during operation of the pump 30 and cannot be removed by an operator by hand. Thus during operation of the pump 30 the body is in a locked orientation and an abutment between the stop 124 and the connecting assembly 400 will prevent an unwanted loosening of the nut 555.

The device 100 can be removed from the nut 555 by adjusting the body 102 to an unlocked orientation from the locked orientation. The device is then in a removable orientation. In the removable orientation and unlocked orientation, an operator can remove the device 102 by hand from the nut 555. To affect removal an operator, while holding the first body 104 and post 106 stationary, if desired, moves and pivots the second body 108 first portion 118 and post 110 relative to the first body portion 104 and post 106 to move the first portion 118 and post 110 in the first arcuate directions along the arcuate paths 122, 122′. The movement of portion 118 causes the second post 110 to move and pivot, relative to body 104 and post 106, in and through open end 116′ of hole 116. The open end 116′ opens through nut first surface 55′. The movement of the post 110 is in the direction out the hole. The movement is out the hole. The movement of the second post 110 in open end 116′ of the hole 116 and in the direction out the hole 116 allows the operator to next remove the first post 106 from hole 114 and thus remove the device 100 from the nut 555. Hinge 112 allows the above movements.

In more detail the body 102 of the device 100 has a first surface 126a, 126b, at a first section of the body, spaced from a second surface 128a, 128b, at a second section of the body. When the body 102 is in the set position, the first surface 126a, 126b and the second surface 128a, 128b are each curvilinear and arcuate. The first surface 126a, 126b has a first radius 130 which extends from an axis. The second surface 128a, 128b has a second radius 136 which extends from the same axis as the first surface. The second radius 136 is shorter than the first radius 130.

The first body 104 has first body first surface 126a, at a first section of first body 104. Surface 126a and first section of first body 104, forms a portion of the body's 102 first surface and first section. The surface 126a is curvilinear and arcuate. The surface 126a has the first radius 130.

The second body 108 has second body first surface 126b at a first section of the second body. Surface 126b and first section of second body forms a portion of the body 102 first surface and first section. The surface 126b is curvilinear and arcuate. The surface has the first radius 130.

The first body 104 has a first body second surface 128a at a second section of first body. The second surface 128a and second section of first body 104 forms a portion of the body 102 second surface and second section. The surface 128a is curvilinear and arcuate. The surface has the second radius 136. The first post 106 extends away from the second surface 128a and second section of first body 104 and is coupled at the second section and second surface 128a to body 102. The first body 104 has a first end portion 134 which can exclude the first post 106. When the body is in the unlocked orientation, first surface 126a, the second surface 128a, first section and second section of first body 104, post 106, first end portion 134, and first section and second section at the first portion 134 of the first body 104 are moveable and pivotal relative to the second body 108, first portion 118 of second body, and post 110. The first portion 134; first surface 126a; second surface 126b; first section; and second section; each of the first body 104 are moveable and pivotal along a third arcuate path and direction as shown by arrow 146, and once moved in the third arcuate direction and path, from when the body 102 is in the set position, in an opposite fourth arcuate path and direction shown by arrow 148. The post 106 is moveable and pivotal in another third arcuate path and direction shown by arrows 146′ similar to path and direction 146. The post 106 pivots and moves in path and direction 146′ when the first portion 134; first surface 126a; second surface 126b; first section, or second section, each of the first body 104, move in direction 146. The post once moved along path and in direction 146′, from when body 102 is in a set position, is moveable and pivotal in another fourth arcuate path and direction 148′ which is opposite path and direction 146′. Path and direction 148′ is similar to path and direction 148. Post 106 moves and pivots in direction and path 148′ when the first portion 134; first surface 126a; second surface 128a; first section; or second section, each of the first body 104, moves in path and direction 148. Hinge 112 allows the above movements. The above movements are possible when the second body 108 and or post 110 are held stationary.

The second body 108 has a second body second surface 128b at a second section of second body. The surface 128b and second section of second body 108 forms a portion of the body 102 second surface and second section. The surface 128b is curvilinear and arcuate. The surface has the second radius 136. The second post 110 extends away from the second surface 128b and second section of second body 108 and is coupled at the second section and second surface 128b to body 102. In the unlocked orientation, first surface 128a; second surface 128b; first section; second section; first section and second section at the first portion 118, and first end portion, all of the second body 108 are moveable and pivotal along first arcuate path and direction 122 and once moved in the first arcuate direction and path, from when the body 102 is in the set position, in the opposite second arcuate path and direction 120. Hinge 112 allows the above movements. The above movements are possible when the first body 104 and or post 106 are held stationary.

The first body 104 first surface 126a is spaced from the first body 104 second surface 128a. The spacing is in the radial direction. The second body 108 first surface 126b is spaced from the second body 108 second surface 128b. The spacing is in the radial direction.

The surfaces 126a, 126b, 128a, 128b are exclusive of the posts 106, 110.

A third surface 138′ forming a first side 138 of the first body 104 joins first body first 126a and second 126b surfaces. A fourth surface 140′ forming a second side 140 of the first body 104, facing an opposite direction then the third face surface 138′, also joins first body first 126a and second 128a surfaces. The first body first 126a and second 128a surfaces respectively are at third and fourth oppositely facing sides of the first body. The surfaces 126a, 128a, respectively delimit boundaries of the first and second sections of first body 104. Accordingly the third and fourth sides are at the first and second sections of the first body.

A third surface 142′ forming a first side 142 of the second body 108 joins second body first 126b and second 128b surfaces. A fourth surface 144′ forming a second side 144 of the second body, facing an opposite direction then the third surface 142′, also joins second body first 126b and second 128b surfaces. The second body first 126b and second surfaces 128b, respectively are at third and fourth oppositely facing sides of the second body. The first and second surfaces, respectively delimit boundaries of the first and second sections of second body. Accordingly the third and fourth sides are at the first and second sections of second body.

As stated, hinge 112 when the body 102 is in an unlocked orientation allows first 104 and second 108 body to each pivot and move relative to each other. The hinge 112 includes a flange 156. The flange can be called an arm, ear or extension. The flange has a through hole-162 extending there through. The flange 156 extends from a portion of a second end portion 160 of the first body portion 104. The flange 156 is integral with the portion from which it extends and forms an integral part of the first body portion 10. The hinge 112 also includes a hole 152 through a portion of the second end portion 154 of the second body 108. The flange 156 is disposed to be adjacent and across, in the axial direction, from the portion of the end portion 154 having hole 152. The flange 156 is coupled to the portion of the end portion 154 having the hole 152 by a pin 166. Pin 166 extends into and is carried in holes 152 and 162. The first 104 and second 108 body portions move and pivot relative to each other at the pin 166. The hole 152 is oriented to extend through the third surface 142′ and first side 142 of the second body 108 in a direction to and through the fourth surface 144′ and second side 144 of the second body 108. The third surface 142′ can be called a first face surface. The fourth surface 144′ can be called a second face surface. The axis of hole 152, which extends through opposite open ends of the hole 152, extends in the axial direction. The direction is from the first face surface 142′ and first side 142 of the second body 108 to the second face 144′ and second side 144 of the second body 108. Hole 162 has an axis that passes through opposite open ends of hole 162. The axis extend in a direction from the third surface 138′, also called the first face surface 138′ and first side 138 of first body 104 to the fourth surface 140′, also called the second face surface 140′, and second side 140 of first body 104.

The first and second body portions 104, 108 have constructions at their second end portions 154, 160 which limit and stop the pivotal movement of the second body 108, first portion section 118 and post 110 in the first arcuate path and directions 122, 122′ relative to the first post 106 and first body 104. The constructions also limit and stop the pivotal movement of the first body 104, first portion 134, and post 106 in the third arcuate path and directions 146, 146′. The movements are limited by an abutment of a portion of an end surface 154′ at the second end portion 154 of the second body 108 against a portion of an end surface 160′ at the second end portion 160 of the first body 104.

The first and second bodies 104, 108 also have constructions to limit and stop the pivotal movement of the second body 108, the first portion 118, and post 110 in the second arcuate direction and path 120, 120′ relative to the first body 104 and post 106. The constructions also limit and stop the pivotal movement of first body 104, the first end portion 134 and post 106 in the fourth arcuate directions 148, 148′. The movements are limited when the body 102 is in the set position. In the set position a portion of surface 160′ at the second end portion 160 of the first body portion 104 abuts up against a portion of surface 154′ at the second end portion 154 of the second body portion 108.

A lock 168 allows for adjustment of the body 102 to the locked orientation from the unlocked orientation and from the unlocked orientation to the locked orientation. The lock 168 includes a hole 170 extending into a portion of the end surface 154′ at the second end portion 154 of the second body 108. The hole 170 extends into a flange 150 formed in part by the portion of end surface 154′ in which the hole extends. The flange 150 can be called or raised portion or portion extending radially outward and away from the first surface 126b and the axis of the first surface 126a, 126b. Outward is generally a second body first direction 172 from the second body second surface 128b and second section towards the second body first surface 126b and first section and away from the first surface 128a and first section. The hole 170 extends in a direction from the second end portion 154 to the first end portion 118 of the second body 108. The hole is parallel to the first 142 and second 144 sides of the second body 108. The lock also includes a portion of first surface 126a which supports a portion of a pin 180. The portion which supports a portion of the pin 180 is a recessed area in first surface 126a of first body. The recess is made of a first portion 174 which receives a shaft portion of a pin 180 and a second portion 176 which receives a head portion of the pin 180. A first body first direction 178 is generally a direction which points from the first body second surface 128a and second section to the first body first surface 126a and first section and away from the first surface 126a and first section. The lock's pin 180 which extends into hole 170 and sits in recesses 174 and 176 and is carried in the hole 170 when the body 102 is in the locked orientation. When the pin 180 is out of the hole 170, the body is in the unlocked orientation. The pin 180, when the body is in a locked orientation, is in a fixed orientation. The pin when in the fixed orientation is inhibited from exiting through hole 170 compared to when the pin 180 is not in a fixed orientation. In the fixed orientation the pin will not fall out of the hole 170 when the device 100 is coupled to nut 555 and the pump is in operation. To unlock the body 102 from the locked orientation to an unlocked orientation the pin is adjusted, by the hand of an operator, to an unfixed orientation, i.e. the pin is adjusted so it is not in a fixed orientation. The pin 180 is then removed, by the hand of an operator, from the hole 170. The pin 180 used in the present example is a lynch pin. The lynch pin includes a latch 182. When the latch 182 is in a first position the latch does not overlap flange 150. The pin 180 is unfixed. When the pin 180 is in a second position the latch 182 overlaps flange 150. The pin 180 is in the fixed position.

The device's stop portion 124 can also be called a stop 124 or an abutment 124. The stop 124 is spaced, when the device is installed on the nut 555 and in the locked orientation, outward and away from the first surface 55′ of the nut 555 in the first direction 172 of the second body 108. The stop is outward from the axis 184 of the nut. The space is a distance measured along a shortest straight line from the nut surface 55′ of the nut 555 to the most inward abutting surface 124′ of the stop 124 relative to the nut axis 184. The spaced distance of the stop from surface 55′ is greater than the shortest straight line distance between the most inward surface 400′ of the connecting assembly 400 relative to nut axis 184 and the first surface 55′ of the nut 555. Preferably the stop distance is greater than a shortest straight line distance between the connecting assembly axis 45 and the nut axis 184. The stop is spaced in the first direction 172 from the first surface 126b and first section of second body. The stop 124 is an end portion of an arm 125 which extends outward from surface 126b and the first section in the first direction 172.

The connecting assembly 400 is one of a group of connecting assemblies. The group is selected from the plurality of connecting assemblies 40. The assemblies, forming the group of assemblies, are also indicated as 40′ and are arranged at one side of the fluid end 38. Each assembly 40′ of the group is intersected by a plane parallel to all the long axes 45 of the connecting assemblies forming the group 40′. The connecting assembly 400 selected is an assembly first intersected by a straight line extending from the axis 184 of the nut and through the 12 o'clock position on the nut when the nut is turned in the loosening direction 61. The 12 o'clock position is ascertained when looking towards the nut 555 disposed in corresponding plunger bore 49, in and along the longitudinal direction of the nuts axis 184, and into the face surface of the fluid end 28 through which the plunger bore open end 49′ opens. Although the connecting assembly 400 is shown as a combination of a separate tube 44 and stud 42, the assembly could be formed from an integral member which combines a spacing and fastening feature.

The nut first surface 55′ is curvilinear, arcuate and has the same radius as the body first surface 126a, 126b. The nut 555 has a hollow 188. Plunger extends though hollow 188.

The arcuate first direction 122 includes a vector which points in the second body first direction 172. The third arcuate direction includes a vector which points in the first body first direction 178. The second arcuate direction 120 includes a vector which points in a direction 190 from the second body first surface 126b and first section to the second body second surface 128b and second section and away from the second surface 128b and second section. The fourth arcuate direction includes a vector which points in a direction 192 from the first body first surface 126a and first section to the first body second surface 128a and second section and away from the second surface 128a and second section.

The first post 106 of the first body 104 extends in the first body second direction 192 away from surface 128a and second section of first body 104. The post 106 is coupled to and extends from the body 102 at second surface 128a and second section of first body 104. The base of the post 106 is at the second surface 128a and second section of first body 104. The post has a planar surface 194 at its free end, opposite its base. A cylindrical surface 196 extends between and from the base to the free end. Post 106 can be called a protrusion. Surfaces 194 and 196 can be called a surface of the post 106.

Post 110 of second body 108 extends in the second body second direction 190 away from second surface 128b and second section of second body 108. The post 110 can be called a protrusion. The post 110 is coupled to and extends from the body 102 at second surface 128b and second section of second body 108. The base of post 110 is at the second surface 128b and second section. The post 110 is delimited by a surface different from post 106 surface. Post 110 surface has first section at its free end opposite its base. The first section 200 is a planar surface. The post surface has a second section 202. The second section 202 is planar and angled to slant, going in a direction which points from the base of the post to the free end, towards an axis of the post. The axis extends in the direction from the base to the free end. The second section 202 has a length going in the direction of the base to the free end which extends 1.27 cm. The post 110 has a third section 204. The surface is parallel to post 110 axis. The post 110 surface has fourth 206 and fifth 208 sections. Each of the surfaces is at least partially curved. The surfaces are parallel to post 110 axis. The fourth 206 section is between and joins a portion of the second section to the third section. The fifth section 208 is between and joined to a portion of the second section and to a portion of the third section. The second, third, fourth and fifth sections are between the second body's second section and post 110 free end and between second surface 128b and post 110 free end and also between post 110 base and post 110 free end.

The first body 104 is a seamless monoblock piece. The first body first surface 126a and second surface 128a form a monoblock seamless portion of the first body which can be exclusive or inclusive of the first post 106. The second body 108 is a seamless monoblock piece. The second body first surface 126b and second surface 128b form a monoblock seamless portion of the first body which can be inclusive or exclusive of the first post 106. The second body portion 108 handle and stop are a seamless monoblock piece.

In the shown example a structure or surface which is arcuate is also curved. Movement along an arcuate path in an arcuate direction can also be said to be movement along a curved path in a curved direction.

What is claimed is:

1. A plunger pump having a plunger bore, a packing nut extending into an open end of the plunger bore in combination with a device coupled to the packing nut, the combination comprising:
a power end of said pump;
a fluid end of said pump;
a plurality of connecting assemblies of said pump coupling said power end to said fluid end of said pump;
a first body coupled to a second body, said first and second body forming a body of said device;
a first post connected to said body and a second post connected to said body, said first post extending into a first opening and said second post extending into a second opening to couple said device to said packing nut;
a stop forming a portion of said device, wherein when said body is in a locked orientation, said stop abuts or will abut, when said nut is rotated in a loosening direction, one of said connection assemblies;
wherein said body is adjustable between an unlocked orientation and said locked orientation;
wherein in said unlocked orientation, said second post is moveable, relative to said first body and said first post, in a direction out of said second opening, and a first portion of said second body, exclusive of said second post, is moveable in a direction relative to said first body and first post.

2. The combination of the plunger pump and the device coupled to the nut of claim 1 wherein:
said first body is pivotally coupled to said second body.

3. The combination of the plunger pump and the device coupled to the nut of claim 1 wherein:
said relative movement of said first portion in said direction is along a curved path and said relative movement of said second post in a direction out said opening is along a curved path.

4. The combination of the plunger pump and the device coupled to the nut of claim 3 wherein:
a surface at the first portion of the second body is a second curved surface and spaced from a first curved surface of the second body.

5. The combination of the plunger pump and the device coupled to the nut of claim 4 wherein:
wherein the second post extends in a first direction away from the second surface of the second body, the first direction points from the first surface of the second body towards the second surface and away from the second surface.

6. The combination of the plunger pump and the device coupled to the nut of claim 1 wherein:
the first body includes the first post and the second body includes the second post.

7. The combination of the plunger pump and the device coupled to the nut of claim 1, the device further comprises:
a hinge coupling a portion of the first body to a portion of the second body, and the hinge allows for movement, when the body is in the unlocked position, of the second post relative to said first body and said first post, in the direction out said opening, and movement of the first portion of the second body in the direction relative to said first body and first post.

8. The combination of the plunger pump and the device coupled to the nut of claim 7 wherein:
a portion of the first body and a portion of the second body each form portions of the hinge.

9. The combination of the plunger pump and the device coupled to the nut of claim 8 wherein:
the portion or the first body forming the hinge includes a flange at a second end portion of the first body; the portion of the second body forming the hinge is at a second end portion of the second body; the flange and the portion of the second body portion forming the hinge are pivotally coupled to each other.

10. The combination of the plunger pump and the device coupled to the nut of claim 1, the device further comprises:
An adjustable lock allowing for adjustment of the body to the locked orientation from the unlocked orientation and from the unlocked orientation to the locked orientation.

11. The combination of the plunger pump and the device coupled to the nut of claim 10 wherein:
a portion of the first body and a portion of the second body each form portions of the lock.

12. The combination of the plunger pump and the device coupled to the nut of claim 11 wherein:
the portion of the second body forming the lock includes a portion at a second end portion of the second body; the portion at the second end portion having a hole.

13. The combination of the plunger pump and the device coupled to the nut of claim 1 wherein:
the second post has a surface with a section which is between a base of said post and a free end of said post; the section is planar and angled to slant, going in a direction which points from the base of the second post to the free end, towards an axis of the post; the axis extends in the direction from the base to the free end; the second post has a length measured along the axis; the section has a length going in the direction of the base to the free end which extends 1.27 cm.

14. A device adapted to retain a packing nut of a plunger pump from an unwanted loosening during operation of the plunger pump, said device comprising:
a first body pivotally coupled to a second body, said first and second body forming a body;
a first section of said first body and a second section of said first body, said second section having a curved surface;
a first section of said second body and a second section of said second body, said second section having a curved surface;
a first post coupled to said second section of said first body;
a second post coupled to said second section of said second body;
a stop connected to said first section of said second body;
wherein said body is adjustable between an unlocked orientation and a locked orientation;
wherein in said unlocked orientation, said second post is pivotal, relative to said first body and said first post; and
wherein in said unlocked orientation, said first post is pivotal, relative to said second body and said second post.

15. The device of claim 14 wherein:
the second post extends away from the second section of the second body in a direction which points from the first section to the second section of the second body and away from the curved surface of the second body;
the first post extends away from the second section of the first body in a direction which points from the first section to the second section of the first body and away from the curved surface of the first body.

16. The device claim 15, the device further comprises:
a hinge coupling a portion of the first body to a portion of the second body, and the hinge allows for movement, when the body is in the unlocked position, of the second post relative to said first body and said first post; and for movement, when the body is in the unlocked position, of the first post relative to the second body and second post.

17. The device of claim 16 wherein:
a portion of the first body and a portion of the second body each form portions of the hinge.

18. The device of claim 17 wherein:
the portion of the first body forming the hinge includes a flange at an end portion of the first body; the portion of the second body forming the hinge is at a second end portion of the second body; the portion of the second body forming the hinge is pivotally coupled to the flange.

19. The device of claim 15, the device further comprises:
a lock allowing for adjustment of the body to the locked orientation from the unlocked orientation and from the unlocked orientation to the locked orientation.

20. The device of claim 19 wherein:
a portion of the first body and a portion of the second body each form portions of the lock.

21. The device of claim 20 wherein:
the portion or the first body forming the lock includes a portion of a first surface of the first body; the portion of the second body forming the lock includes a hole in an end portion of the second body.

22. The device of claim 15 wherein:
the second post has a surface with a section which is between a base of said post and a free end of said post; the section of the post's surface is planar and angled to slant, going in a direction which points from the base of the second post to the free end of the post, towards an axis of the post; the axis extends in the direction from the base to the free end; the second post has a length measured along the axis; the section of the post's surface has a length going in the direction of the base to the free end which extends 1.27 cm.

23. A method of coupling a device to a surface of a packing nut, said packing nut extending into an open end of a plunger bore of a plunger pump, said coupling to prevent an unwanted loosening of the nut from the open end during operation of the pump, said method comprising:
slidably inserting a first post connected to a body of the device into a first hole to couple of the body to the nut, said body having a first body pivotally connected to a second body;
moving and pivoting a second post connected to the body, relative to the first body and first post, in a second curved direction and along a second curved path and while moving and pivoting the post in the second curved direction and along the second curved path, slidably inserting the second post into a second hole to couple the body to the nut;
restraining the second post's ability to move and pivot, relative to the first body and first post, in a first curved direction and along a first curved path opposite the second curved direction and path;

24. The method of coupling of claim 23 wherein the step of moving and pivoting the second post comprises:
moving and pivoting a first portion 118 of the second body relative to the first body and the first post 106.

25. The method of coupling of claim 23 wherein prior to the step of slidably inserting the first post into the hole, the method comprises the step of:
moving and pivoting the second post, relative to the first body and first post, along the first curved path in the first curved direction.

26. The method of coupling of claim 23 wherein prior to the step of slidably inserting the first post in the first hole, the method comprises the step of:
selecting the first hole and the second hole in which the first and the second post of the device will be inserted so that once the first and second posts have been inserted into the first and second holes and the body forming the first and second body has been oriented to a locked orientation, a stop 124 of the device 100 abuts or will abut, when the packing nut is rotated in the loosening direction, a connecting assembly coupling a fluid end of the pump to a power end of the pump.

27. The method of coupling of claim 23 wherein the step of restraining comprises:
adjusting the body from an unlocked to a locked orientation.

28. A method of removing a device coupled to a packing nut, said packing nut extending into an open end of a plunger bore of a plunger pump, said device has a body which includes a first body pivotally coupled to a second body, and a first post is coupled to said body and a second post is coupled to said body, said first post is in a first hole and said second post is in a second hole to couple the body to the nut, said method comprising:
unrestraining the ability of the second post connected to the body to move and pivot, relative to the first body and first post in a first curved direction and along a first curved path;
pivoting and moving the second post, relative to the first body and post in the first curved direction and along the first curved path in a direction out the second hole;
removing the first post from the first hole.
